(19) United States
(12) Patent Application Publication
(10) Pub. No.: US 2004/0100874 A1
(43) Pub. Date: May 27, 2004

(54) Electronic device with interchangeable faceplate

(76) Inventors: Chee Ann Chang, Hong Kong (CN); Kai Wai Wu, Hong Kong (CN); Wai Man Yuen, Hong Kong (CN)

Correspondence Address: LATHROP & GAGE LC, 2345 GRAND AVENUE, SUITE 2800, KANSAS CITY, MO, 64108, US

(21) Appl. No.: 10/302,657

(22) Filed: Nov. 22, 2002

(51) Int. Cl. G04C 17/00; G04B 19/00; G04B 25/00

(52) U.S. Cl. 368/223

(57) ABSTRACT

An electronic device with interchangeable faceplate assembly is described. The assembly provides a faceplate with a viewing region, an electronic device having a device housing for interfacing with the faceplate, and a means for coupling the faceplate to the device housing to define a front viewing panel for the electronic device. A number of faceplate configurations may be implemented for coupling with the device housing.

### BACKGROUND

Household consumer electronics devices, such as alarm clocks, digital readout thermometers, radios, etc., typically have a housing that encases internal electronics performing the operations of the device. This housing may have a particular shape or “look” that is designed to be aesthetically pleasing to a user of the device. However, once the device is purchased, the consumer is stuck with a device having a certain look that is essentially unmodifiable. If a new look is desired for a particular type of device, for example an alarm/radio clock, the consumer must purchase a whole new clock with a different housing style, resulting in increased costs and an unnecessary extra alarm clock, thus being non-environmentally friendly.

### SUMMARY

In one aspect, an electronic device with an interchangeable faceplate is provided. Various faceplates having differing design characteristics may each be interfaced with a housing of the electronic device to define a front panel for viewing.

In another aspect, the faceplates may each have a transparent or semi-transparent viewing region configured for alignment with a display of the electronic device when the faceplate is coupled to the device housing. In this way, information provided on the display (e.g., time, date, temperature, etc.) can be viewed through the faceplate.

In another aspect, the device housing may have a hemispherical shape, or may have a square shaped or a triangularly shaped cross-section. The hemispherically shaped device housing may also have a footing extending from a lower portion of the device housing to support the electronic device in an upright position for viewing thereof.

In yet another aspect, features are provided for coupling and decoupling various faceplates to the device housing. In one aspect, a pair of push-buttons are disposed on the device housing to releasably engage a faceplate. The push-buttons may be laterally spaced apart on the device housing and may each have a catch for securing a hook of a pin extending from the back side of the faceplate. To release the faceplate from engagement with the device housing, the push-buttons are inwardly depressed to release the faceplate pin hooks from the catches, allowing the faceplate to be pulled away from the device housing. Likewise, to secure a faceplate to the device housing, the faceplate pin hooks are inserted into the catches of the push-buttons to engage the catches and lock the faceplate with the device housing.

In another aspect, a threaded ring is formed on a back surface of one faceplate and is configured for receiving a perimeter threaded region of the device housing. In this way, the faceplate may be screwed onto and off of the device housing.

In yet another aspect, a flange extends from an upper point of the device housing adjacent to a front surface thereof and is configured to be frictionally fit within a slot formed on the back surface of the faceplate. To secure the faceplate onto the device housing, the faceplate is slid upward such that the slot engages the flange of the device housing. Removal of the faceplate is accomplished by sliding the faceplate in the opposite direction.

In yet another aspect, the device housing has a circumferential ring with a plurality of bores; and the faceplate has a corresponding set of through-holes alignable with the bores. Fasteners may be inserted through the through-holes of the faceplate and bores of the device housing to secure the same together.

In still another aspect, a pair of angled flanges are formed on the front surface of the device housing, and mating angled flanges are formed on the rear surface of the faceplate. Coupling of the faceplate to the device housing may be achieved by sliding the angled flanges of the faceplate over the angled flanges of the device housing either upwardly or downwardly, to frictionally fit therewith.

In still another aspect, the faceplate may be secured to the device housing by forcing a ring of the faceplate around the perimeter of the device housing. The faceplate ring has an inner circumferential lip that is configured to fit over an outer lip of the device housing in an interference fit.

The electronic device with interchangeable faceplate provides for more flexibility in the look of an electronic device. The faceplate may take on a variety of shapes and designs, such as seasonal designs (e.g., snowman, Christmas tree, pumpkin, Easter bunny, country flag), sports teams themes, color patterns (e.g., leopard print, camouflage), and others. Also, the multiple faceplates allow a consumer to have less clutter, as compared to multiple electronic devices, while still displaying a particular style or theme. For example, instead of displaying a seasonal item, such as a snowman figurine, on a desk next to the electronic device with faceplate, the consumer can merely attach a snowman faceplate to the device housing to display the theme, essentially providing a 2-in-1 product.

### BRIEF DESCRIPTION OF THE DRAWINGS

FIGS. 1A-1D show various views (perspective view, side view, front view and back view) of one electronic device with interchangeable faceplate;

FIGS. 2A-2D show various views (perspective view, front view, side view and back view) of another electronic device with interchangeable faceplate;

FIG. 3A is a top cross-sectional view of another electronic device with interchangeable faceplate, taken along line 3-3, showing one faceplate coupled to one device housing;

FIG. 3B is a top cross-sectional view of the electronic device with interchangeable faceplate of FIG. 3A, showing the direction of depression of one pair of push-buttons of the device housing to release the faceplate from the device housing;

FIG. 3C is a top cross-sectional view of the electronic device with interchangeable faceplate of FIG. 3A, showing the direction of movement of the faceplate away from the device housing subsequent to releasing the faceplate;

FIG. 3D is a top cross-sectional view of the electronic device with interchangeable faceplate of FIG. 3A, showing the push-buttons returning to the original position after being released;

FIG. 4A is a partial close-up view of the electronic device with interchangeable faceplate of FIG. 3A;

FIG. 4B is a partial close-up view of the electronic device with interchangeable faceplate of FIG. 3B;

FIG. 5A is an exploded view of another electronic device with interchangeable faceplate;

FIG. 5B is a side view of the electronic device of FIG. 5A;

FIG. 5C is a back perspective view of the faceplate of FIG. 5A;

FIG. 6A is an exploded view of another electronic device with interchangeable faceplate;

FIG. 6B is a side view of the electronic device of FIG. 6A;

FIG. 6C is a back perspective view of the faceplate of FIG. 6A;

FIG. 7A is an exploded view of another electronic device with interchangeable faceplate;

FIG. 7B shows one fastener suitable for use with the electronic device with interchangeable faceplate of FIG. 7A;

FIG. 8A is an exploded view of another electronic device with interchangeable faceplate;

FIG. 8B is a top view of the faceplate of FIG. 8A; FIG. 8B is a top view of the electronic device of FIG. 8A;

FIG. 9A is an exploded view of another electronic device with interchangeable faceplate;

FIG. 9B is a cross-sectional view of the faceplate of FIG. 9A, taken along line 9-9;

FIG. 9C is a back perspective view of the faceplate of FIG. 9A.

FIGS. 10A-10E show various design features of five interchangeable faceplates, respectively, and attached to an electronic device;

FIGS. 11 and 11B each show various design features of two interchangeable faceplates;

FIGS. 12A-12F show various views (top view, front perspective view, back perspective view, front view, side view, and back view) of another interchangeable faceplate attached to an electronic device;

FIGS. 13A-13E show various views (top view, perspective view, front view, side view, and back view) of another interchangeable faceplate attached to an electronic device;

FIGS. 14A-14E show various views (top view, perspective view, front view, side view, and back view) of another interchangeable faceplate attached to an electronic device;

FIGS. 15A-15E show various views (top view, perspective view, front view, side view, and back view) of another interchangeable faceplate attached to an electronic device;

FIGS. 16A-16E show various views (top view, perspective view, front view, side view, and back view) of another interchangeable faceplate attached to an electronic device;

FIGS. 17A-17E show various views (top view, perspective view, front view, side view, and back view) of another interchangeable faceplate attached to an electronic device;

FIGS. 18A-18E show various views (top view, perspective view, front view, side view, and back view) of another interchangeable faceplate attached to an electronic device;

FIGS. 19A-19E show various views (top view, perspective view, front view, side view, and back view) of another interchangeable faceplate attached to an electronic device;

FIGS. 20A-20E show various views (top view, perspective view, front view, side view, and back view) of another interchangeable faceplate attached to an electronic device.

FIGS. 21A-21F show various views (top view, front perspective view, back perspective view, front view, side view, and back view) of another interchangeable faceplate attached to an electronic device.

FIGS. 22A-22E show various views (top view, perspective view, front view, side view, and back view) of another interchangeable faceplate attached to an electronic device.

### DETAILED DESCRIPTION OF THE INVENTION

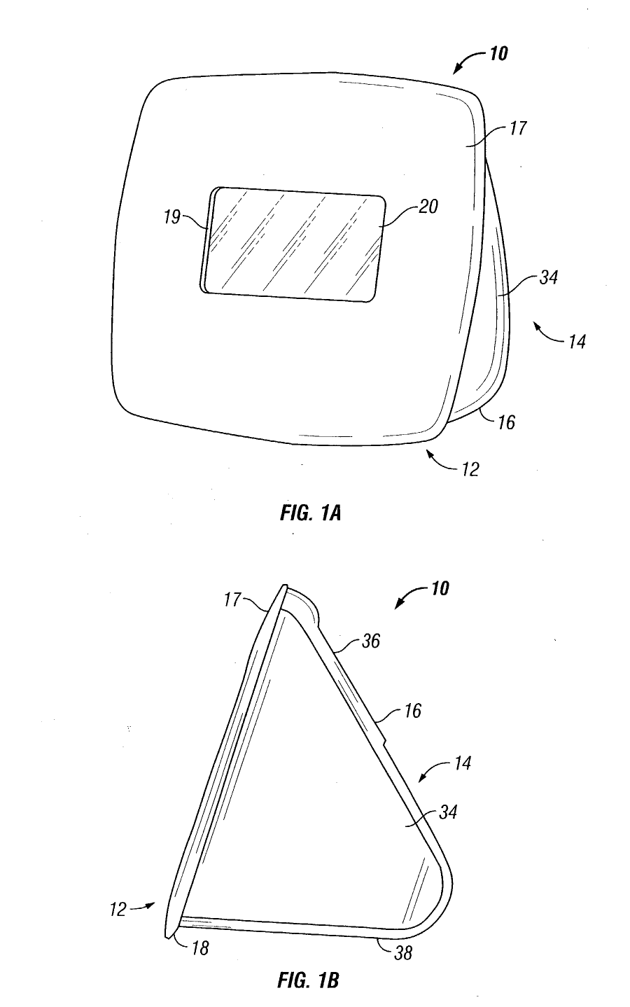

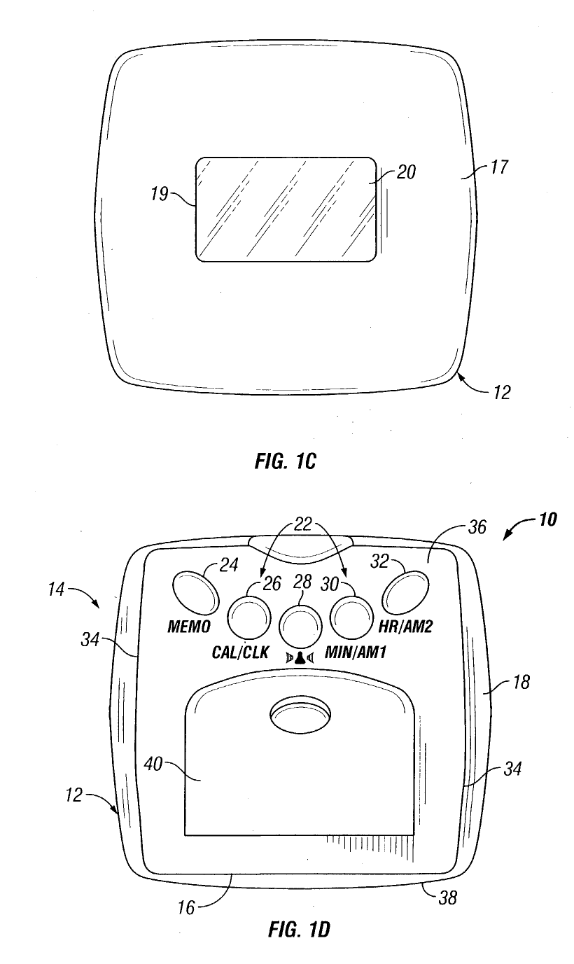

FIGS. 1A-1D show one electronic device and faceplate assembly 10. Assembly 10 is formed by a faceplate 12 and an electronic device 14 contained within a device housing 16. Faceplate 12 and device housing 16 may, for example, be made of moldable plastic or other composite material. Faceplate 12 has a front surface 17, a back surface 18, and a viewing region 19, through which a display 20 (e.g., a digital display) of electronic device 14 may be seen. Front surface 17 may have various design features that are viewed by a user when faceplate 12 is coupled to device housing 16. Viewing region 19 may be a window formed of a transparent or semi-transparent material (e.g., glass or plastic), or may be through-hole in faceplate 12. A number of input buttons 22 may be formed on device housing 16 for directing the operation of electronic device 14, as seen in FIG. 1D. In an exemplary arrangement, when electronic device 14 is a combined alarm clock, voice memo recorder, and digital thermometer as shown in FIGS. 1A-1D, input buttons 22 may include “Memo” button 24 for recording and playback of voice messages, “Cal/Clk” button 26 for toggling between a calendar and a clock display mode, Station button 28 for selecting a particular remote station for displaying the weather conditions (e.g., temperature) prevalent at that station, “Min/AM 2” button 30 for advancing the minute component of either the displayed time or an alarm, or for displaying a secondary alarm time, and “HR/AM 1” button 32 for advancing the hour component of either the displayed time or an alarm, or for displaying a primary alarm time. Device housing 16 has a pair of opposing sidewalls 34 that have a generally triangular shape. A rearward panel 36 extends between sidewalls 34 and is generally downwardly sloping. Input buttons 22 are preferably located on rearward panel 36. A base panel 38, upon which assembly 10 rests, extends between sidewalls 34 and below rearward panel 36. A battery compartment 40, seen in FIG. 1D, and housing a battery (not shown) for powering electronic device 14, may be formed on device housing 16 such that battery compartment 40 extends from rearward panel 36 to base panel 38.

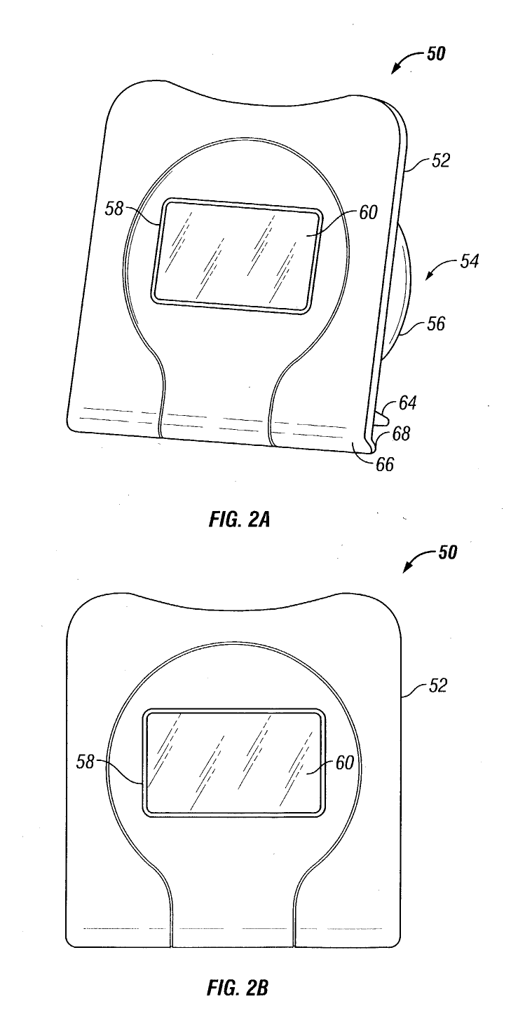

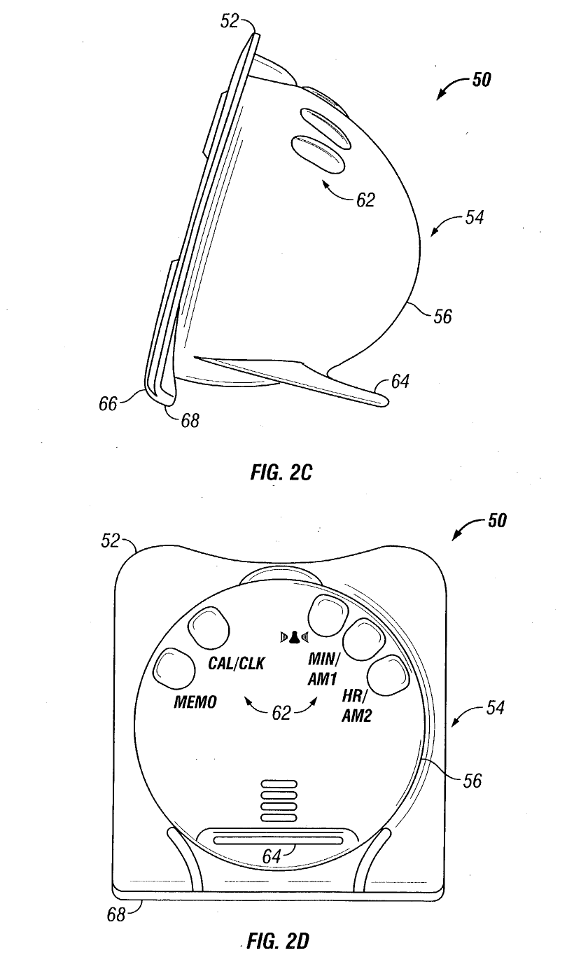

FIGS. 2A-2D show another electronic device and faceplate assembly 50. Assembly 50 is formed by a faceplate 52 and an electronic device 54 contained within a device housing 56, similar to assembly 10 of FIGS. 1A-1D. Assembly 50 may also have input buttons 62. Faceplate 52 also has a viewing region 58 through which a display 60 of electronic device 54 may be seen. A pair of push-buttons 61 may be formed on opposite sides of device housing 56 for releasing faceplate 52 from engagement with device housing 56. Input buttons 62 perform the same functions on electronic device 54 as input buttons 22 of assembly 10, FIG. 1D. Input buttons 62 may have a generally oblong, convex shape. Alternatively, input buttons 62 may have a concave shape recessed into device housing 56 such that the fingers of a user may easily fit onto the structure of one particular button 62, for initiation thereof. Device housing 56 may be hemispherically shaped, such as to form a half-sphere and may have a rearwardly extending flanged footing 64 to support device housing 56. Electronic device 54 may be powered by a battery (not shown) in a manner similar to electronic device 14 of FIG. 1. Faceplate 52 may also have curved lower lip 66 forming a footing 68 cooperating with footing 64 of device housing 56 to support assembly 50 in an upright position.

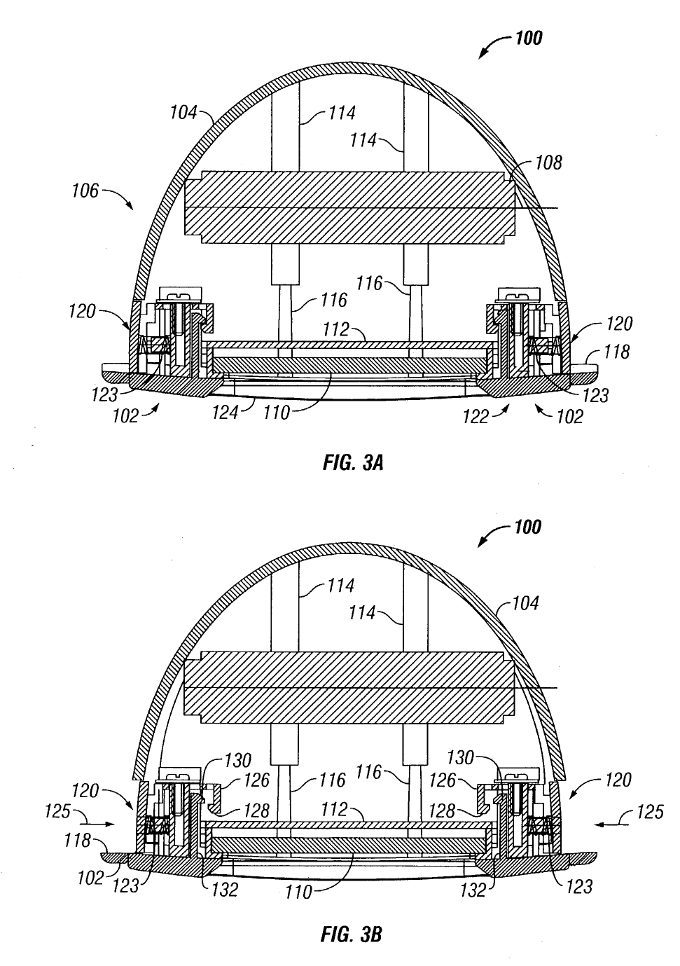

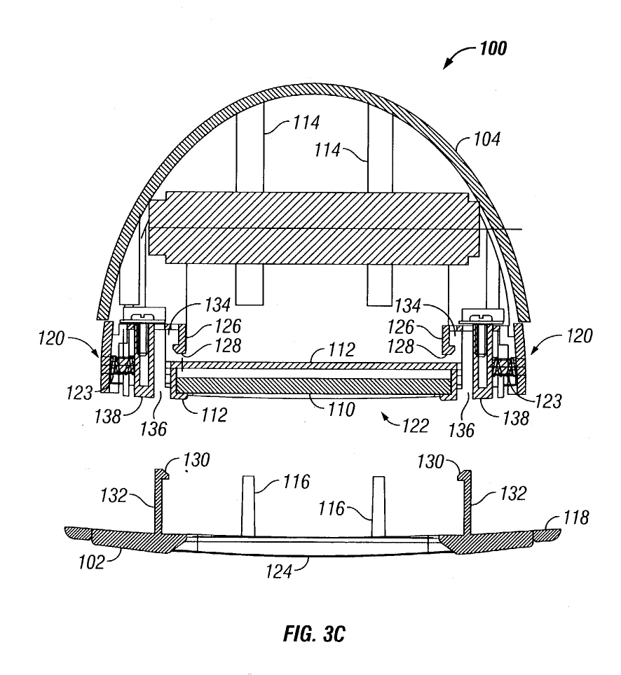

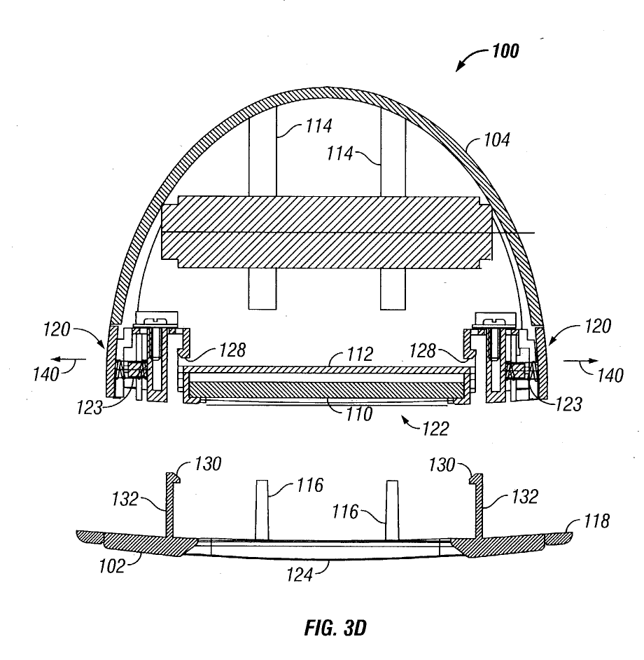

Detaching of one faceplate 102 from one device housing 104 of an electronic device 106 of another electronic device and faceplate assembly 100 is shown in FIGS. 3A-3D. Faceplate 102 and device housing 104 may, for example, be faceplate 12 and device housing 16 of FIGS. 1A-1D, but is shown in FIGS. 3A-3D as having generally the same overall shape as faceplate 52 and device housing 56 of FIGS. 2A-2D.

FIG. 3A shows a cross-sectional view of faceplate 102 and device housing 104 of electronic device 106, taken along line 3-3 though faceplate 52 and device housing 56 of FIG. 2C. Electronic device 106 has internal electronics 108 for performing the functions of electronic device 106 and a display 110 to provide digital readout. Electronics 108 may control the operation of input buttons on device housing 104 similar to input buttons 62, FIG. 2D, as well as the illumination of display 110. Display 110 may be a LCD display or other type of display. Depending on the particular type of electronic device 106, display 110 may provide various data. For example, for an alarm clock, display 110 may show time, date/calendar, and alarm times, among other information. Display 110 may of course show temperature or other data depending on the particular electronic device 106, such as weather forecast information. A frame 112 encloses the display 110 for mounting with device housing 104. Device housing 104 has a pair of braces 114 configured to slidably receive bracing pins 116 below display 110 and extending from a back surface 118 of faceplate 102, to guide and support faceplate 102 when engaging and disengaging with device housing 104. Braces 114 and bracing pins 116 may be sized such that a friction fit is formed therebetween. Alternatively, bracing pins 116 may be configured to slide over braces 114 such that bracing pins 116 slidably receive braces 114 therein. A pair of push-buttons 120, such as push-buttons 61, FIG. 2C, are slidably mounted with device housing 104 and are configured to selectively couple and decouple faceplate 102 with device housing 104. Push-buttons 120 may be located at laterally opposing positions on device housing 104, proximal a forward side 122 thereof such that a user may grasp both push-buttons 120 with one hand. Push-buttons 120 may each also abut a compression spring 123 to bias push-buttons 120 outwardly. Faceplate 102 also has a viewing region 124 positioned above bracing pins 116. Viewing region 124 of faceplate 102 is similar to viewing region 18 of FIG. 1A, and viewing region 58 of FIG. 2A, and aligning with display 110 such that a user may view display 110 through viewing region 124.

FIG. 3B shows the direction of movement of the push-buttons 120 to detach faceplate 102 from device housing 104. Arrows 125 show the direction for applying a force to compress springs 123 and inwardly depress push-buttons 120 to release faceplate 102. Each push-button 120 may have an arm 126 and a catch 128 extending from arm 126 for receiving a hook 130 of a pin 132 extending from back surface 118 of faceplate 102. The inward movement of catch 128 releases hook 130 such that faceplate 102 may be pulled away from device housing 104.

Assembly 100 is shown in FIG. 3C with faceplate 102 fully detached. Device housing 104 is in the same state as in FIG. 3B, with push-buttons 120 depressed and springs 123 compressed before the force applied to push-buttons 120 is released. Each pin 132 and corresponding hook 130 slide out of a holding region 134 and through a slot 136 formed between a guide 138 and display frame 112 to travel away from device housing 104. At this point, bracing pins 116 also slide out of the frictional fit with braces 114.

As the user releases push-buttons 120, the laterally outward force of the compressed springs 123 will return the push-buttons 120 in the direction of arrows 140 to the position shown in FIG. 3D, which is the same as the original position shown in FIG. 3A, but with the faceplate 102 decoupled from device housing 104. Thus, catches 128 are in position to receive hooks 130 of pins 132 extending from faceplate 102. The user may then select another faceplate 102 having the same hook and pin arrangement, but for example, having a different perimeter shape and design pattern on a front surface, such as those shown in FIGS. 1, 2 and 10-20, for attachment to device housing 104.

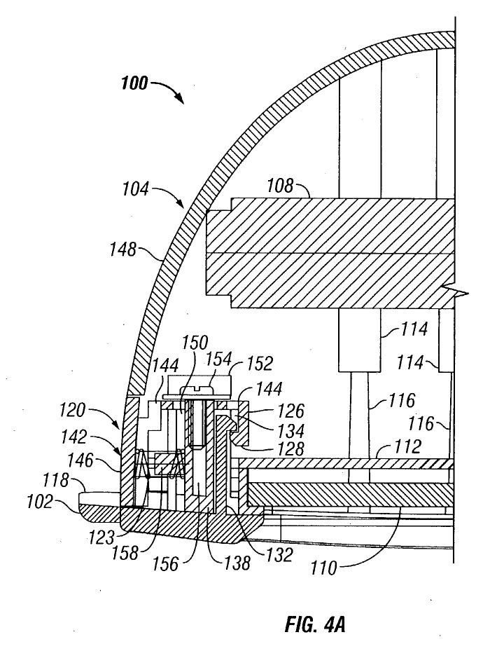

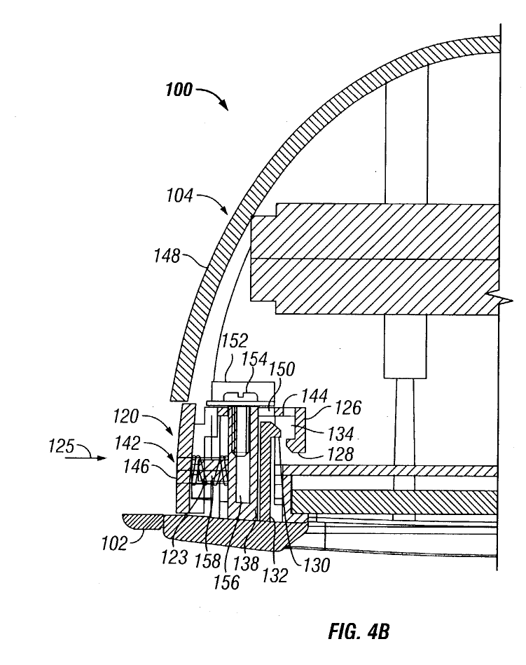

A close-up view of assembly 100 is seen in FIGS. 4A and 4B, and shows the details of one of push-buttons 120. Push-button 120 may have a depression plate 142 and a frame 144 to interconnect arm 126 and catch 128 with depression plate 142. Depression plate 142 may have a surface 146 that generally follows the shape of an outer wall 148 of device housing 104 and is generally aligned flush therewith when no force is applied to plate 142. Arm 126 extends generally in a perpendicular direction from frame 144. Holding region 134, seen in FIG. 4B with push-button 120 depressed, is defined by the region between frame 144, arm 126 and catch 128. Holding region 134 is configured such that hook 130 of pin 132 fits therein to lock faceplate 102 to device housing 104. Both catch 128 and hook 130 may have flat, parallel mating surfaces such that catch 128 and hook 130 may rest securely against one another. A slot 150 is also formed in frame 144 where guide 138 is mounted. Guide 138 has a guide plate 152 that abuts frame 144 to restrict the movement of push-button 120 to a lateral sliding motion. A fastener 154 is provided within a bore 156 of guide 138 to rigidly attach guide plate 152 to guide 138. Spring 123 biases push-button 120 laterally outward so that catch 128 securely holds hook 130, and extends over a support column 158. Support column 158 extends laterally from guide 138 to guide the compression and extension of spring 123 against depression plate 142.

A user will apply an inward force to depression plate 142 of push-button 120 in the direction of arrow 125 sufficient to overcome the laterally outward force provided by spring 123 and compress spring 123, thus moving frame 144, as seen in FIG. 4B. Frame 144 moves laterally along guide plate 152 a distance that may be defined by the width of the slot 150 in which guide 138 is mounted. This movement will cause arm 126 and catch 128 to move laterally away from hook 130 and pin 132. Both of catches 128 of the pair of push-buttons 120 release the corresponding hooks 130 of pins 132 of faceplate 102 to detach faceplate 102 from device housing 104.

To secure faceplate 102 to device housing 104, bracing pins 116 are aligned with, and slid into, braces 114, which aligns an angled surface of each hook 130 of one pin 132 with a corresponding angled surface of each catch 128 of one push-button 120. When the user pushes faceplate 102 into device housing 104, hooks 130 will push catches 128 laterally inward in the direction of arrow 125 as the angled surfaces of each contact one another. At this point, springs 123 will be compressed as depression plates 142 moves inward. When each hook 130 has moved past each catch 128 and into holding region 134, spring 123 will extend and move the corresponding push-button 120 laterally outward to engage hook 130 and secure catch 128 against hook 130, as seen in FIGS. 3A and 4A. Faceplate 102 is then secured to device housing 104.

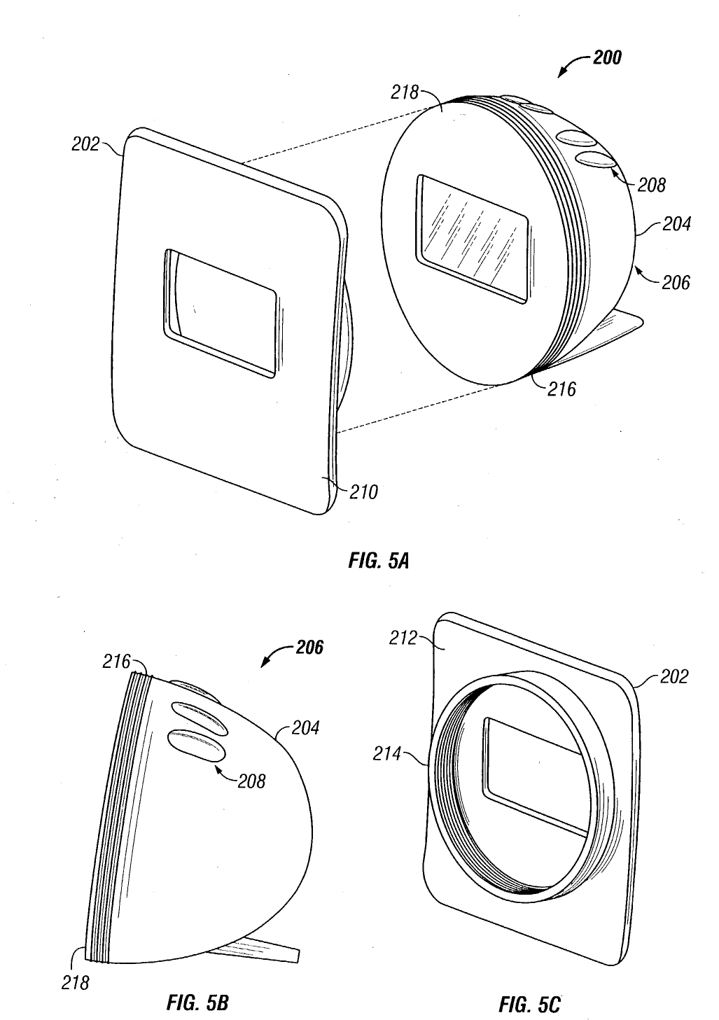

FIGS. 5-9 show other ways of coupling a faceplate to a device housing of an electronic device, such as for faceplate 12 and device housing 16 of FIGS. 1A-1D or faceplate 52 and device housing 56 of FIGS. 2A-2D. Those skilled in the art should appreciate other similar ways of coupling one faceplate to one device housing of an electronic device.

FIGS. 5A-5C show an electronic device and faceplate assembly 200 with a faceplate 202 and a device housing 204 for an electronic device 206. Device housing 204 may for example have generally the same overall shape as device housing 56 of FIGS. 2A-2D, and may have input buttons 208 with similar functionality as input buttons 62 shown in FIG. 2D, for controlling electronic device 206. Faceplate 202 has a front surface 210 viewable when faceplate 202 is attached to device housing 204, and a back surface 212, with a threaded ring 214 formed on the back surface 212 thereof. Likewise, device housing 204 has a threaded region 216 extending around the circumference of device housing 204 near a forward side 218 thereof. Threaded region 216 has threads that match the pitch and angle of threads within threaded ring 214. In this way, a user may grasp faceplate 202 and rotate or screw (e.g., clockwise) threaded ring 214 onto threaded region 216 to secure faceplate 202 onto device housing 204. Conversely, faceplate 202 may be turned in the opposite direction (e.g., counter-clockwise) to unscrew threaded ring 214 from threaded region 216 and remove faceplate 202 from device housing 204.

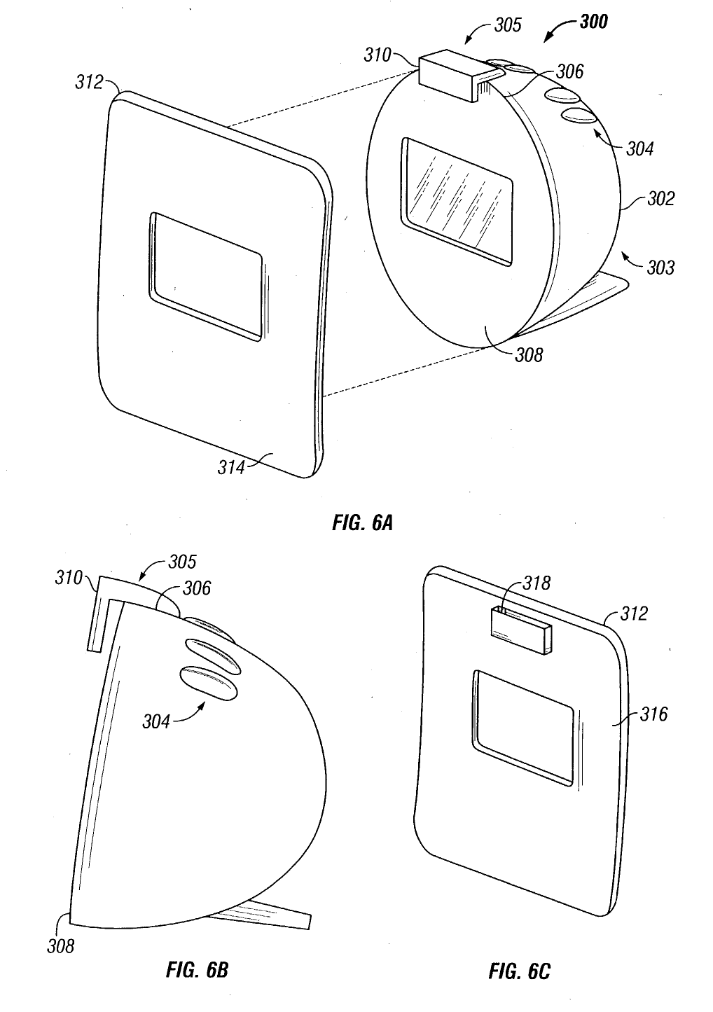

Another electronic device and faceplate assembly 300 is shown in FIGS. 6A-6C. A device housing 302 for an electronic device 303, like device housing 204 of FIGS. 5A-5C, may be generally shaped like device housing 56 of FIGS. 2A-2D and may have input buttons 304 similar to those of assembly 200. Device housing 302 has an angled flange 305 that may be formed at an upper point 306 of device housing 302 adjacent to a forward side 308 thereof. Flange 305 has an arm 310 that extends downward and is offset from forward side 308 of device housing 302. A faceplate 312 has a front surface 314 viewable when faceplate 312 is attached to device housing 302, and, as seen in FIG. 6C, a back surface 316 with an upwardly facing pocket-type slot 318 formed thereon. Slot 318 is sized and configured to receive arm 310 of flange 305 therein in a friction fit. Faceplate 312 may be slid upward along forward side 308 of device housing 302 such that slot 318 slides over arm 310 to couple faceplate 312 to device housing 302. Sliding faceplate 312 downward likewise decouples faceplate 312 from device housing 302. Alternatively, arm 310 may be upwardly extending and slot 318 may be downwardly facing such that faceplate 312 is slid downwardly to couple faceplate 312 to device housing 302.

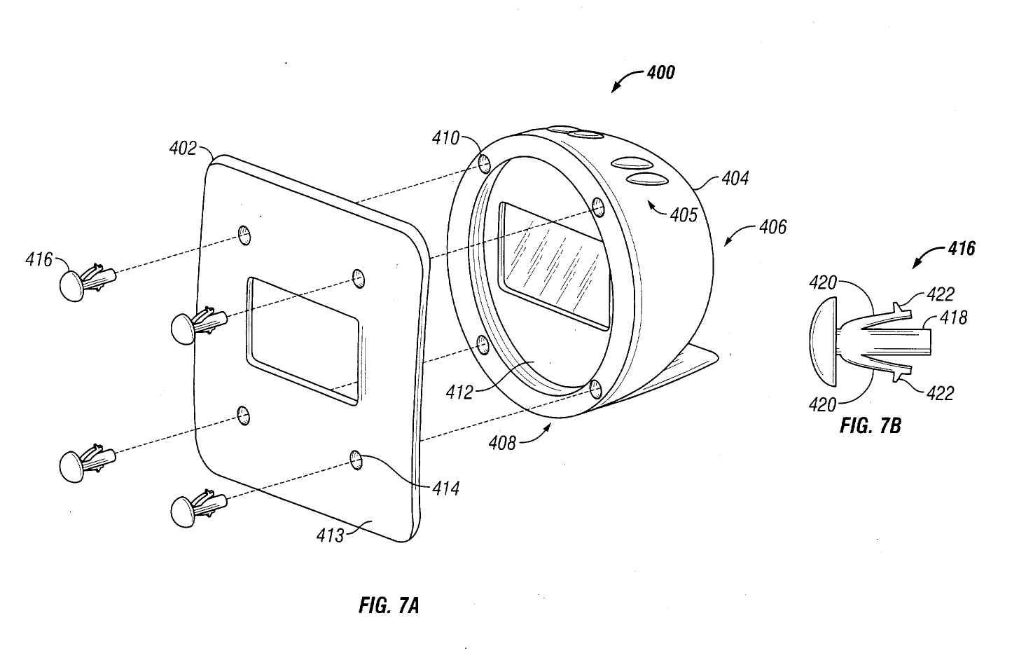

FIGS. 7A and 7B show an electronic device and faceplate assembly 400 having faceplate 402 and a device housing 404 for an electronic device 406. Device housing 404 may be similar to device housing 204 of FIGS. 5A-5C, and may be generally shaped like device housing 56 of FIGS. 2A-2D, with input buttons 405 similar to those of assembly 200. Device housing 404 may have a circumferential ring 408 with a plurality of bores 410 in longitudinal alignment away from a forward side 412 of device housing 404. Alternatively, bores 410 may be provided on forward side 412 of device housing 404 without ring 408. Faceplate 402 has a front surface 413 viewable when faceplate 402 is attached to device housing 404, and a plurality of through-holes 414 that are alignable with bores 410 of device housing 404. A plurality of fasteners 416 are sized to extend into through-holes 414 of faceplate 402 and into bores 410 of device housing 404, to rigidly connect faceplate 402 to device housing 404. As seen in FIG. 7B, fasteners 416 may be rivet-type with a shaft 418 having a pair of flexible arms 420 each having a protrusion-type barb 422. Fasteners may be of other type for removably attaching faceplate 402 to device housing 404, such as screws. To insert the fastener 416 into one through-hole 414 of faceplate 402 and one bore 410 of device housing 404, arms 420 may be pressed inward toward shaft 418 to fit within through-hole 414 and bore 410. Barbs 422 have sloped leading edges such that barbs 422 slide more easily into through-holes 414 and bores 410. The barbs 422 create a friction fit to aid in maintaining fasteners 416 within through-hole 414 and bore 410 to secure faceplate 402 with device housing 404. To remove faceplate 402, arms 420 may again be pressed inward toward shaft 418 such that barbs 422 are moved out of contact with through-hole 414 and bore 410, and the corresponding fastener 416 may be pulled out of through-hole 414 and bore 410. Once all fasteners 416 are removed, the faceplate 402 is decoupled from device housing 404.

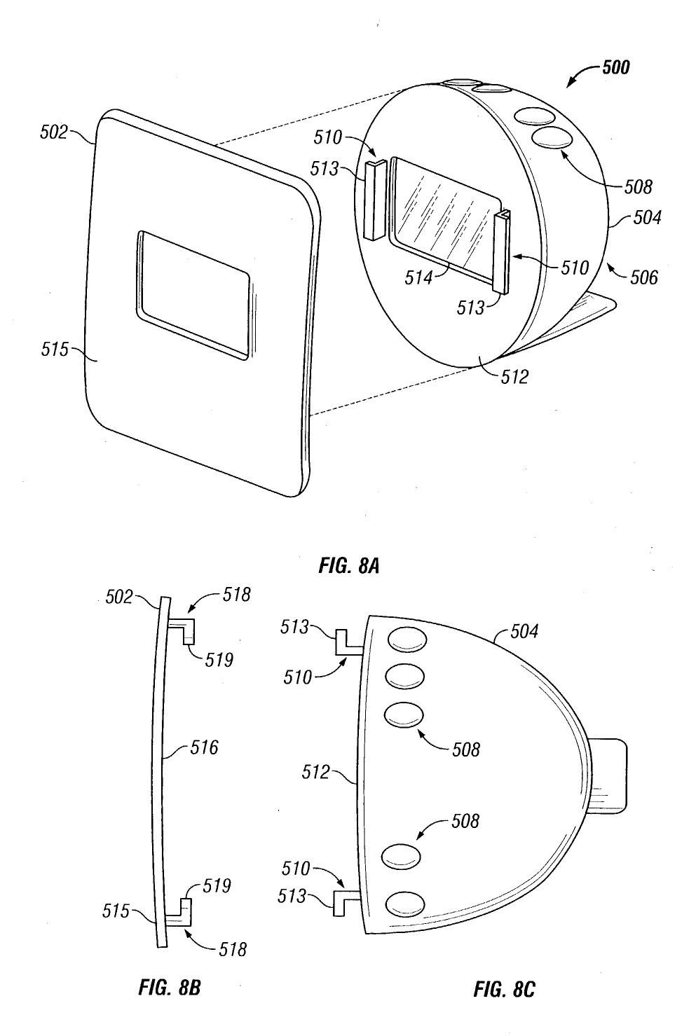

Another electronic device and faceplate assembly 500 is shown in FIGS. 8A-8C. Assembly 500 has a faceplate 502 and a device housing 504 for an electronic device 506. Device housing 504 may be similar to device housing 204 of FIGS. 5A-5C, and may be generally shaped like device housing 56 of FIGS. 2A-2D, with input buttons 508 similar to those of assembly 200. Device housing 504 has a pair of vertically-aligned angled flanges 510 formed onto a forward side 512 of device housing 504, with an arm 513 extending laterally outward therefrom. Angled flanges 510 may be positioned on opposite sides of a display 514 of device housing 504. Faceplate 502 has a front surface 515 viewable when faceplate 502 is attached to device housing 504, and back surface 516 having a pair of vertically-aligned angled flanges 518 formed thereon, as seen in FIG. 8B, each with an arm 519 extending laterally outward therefrom. Angled flanges 518 of faceplate 502 are configured to mate with angled flanges 510 of device housing 504 such that arms 513 of flanges 510 frictionally fit between arms 519 of flanges 518 and faceplate back surface 516. Faceplate 502 may be slid upward or downward along forward side 512 of device housing 504 such that flanges 518 of faceplate 502 engage with flanges 510 of device housing 504 to removably attach or detach face plate 502. In another arrangement, angled flanges 510 of device housing 504, and angled flanges 518 of faceplate 502, may be horizontally-aligned such that faceplate may be slid horizontally in either direction along forward side 512 of device housing 504 to engage flanges 518 of faceplate 502 with flanges 510 of device housing 504.

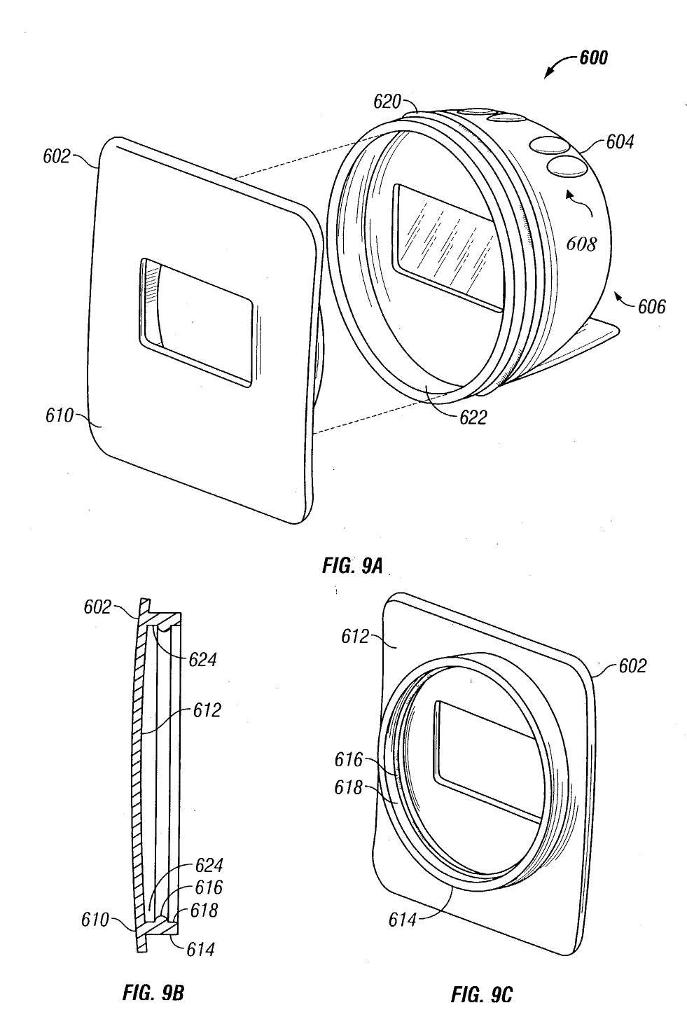

FIGS. 9A-9C show an electronic device and faceplate assembly 600 having a faceplate 602 and a device housing 604 for an electronic device 606. Device housing 604 may be similar to device housing 204 of FIGS. SA-5C, and may be generally shaped like device housing 56 of FIGS. 2A-2D, with input buttons 608 similar to those of assembly 200. Faceplate 602 has a front surface 610 viewable when faceplate 602 is attached to device housing 604, and a back surface 612 having a ring 614 formed thereon. Ring 614 has a circumferential lip 616 formed on an inner surface 618 thereof. Likewise, device housing 604 has an outer lip 620 formed around the circumference of device housing 604 and is configured to mate with lip 616 of faceplate 602. Outer lip 620 is preferably located proximal to a forward side 622 of device housing 604 such that lip 620 may be received in a space 624 formed between circumferential lip 616 and back surface 612 of faceplate 602. To couple faceplate 602 to device housing 604, ring 614 is aligned to surround forward side 622 of device housing 604 and is pressed onto device housing 604. At this point, circumferential lip 616 of faceplate 602 presses against, and if a sufficient force is applied, slides over outer lip 620 of device housing 604 in an interference fit; the inside diameter of circumferential lip 616 of faceplate 602 is slightly smaller than the outside diameter of outer lip 620 of device housing 604. Faceplate 602 is then coupled to device housing 604. To remove faceplate 602, the user pulls faceplate 602 away from device housing 604 with a sufficient force as to overcome the interference fit.

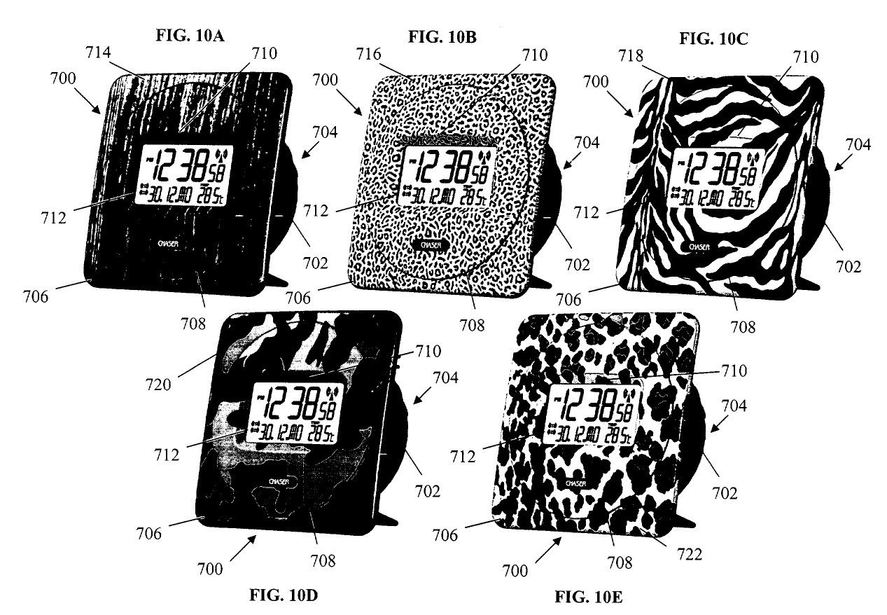

FIGS. 10A-10E show one series of faceplates 700 each connected to a device housing 702 for an electronic device 704, and each having the same structure and shape, but having varying design features. Faceplates 700 have a generally rectangular, or more specifically, square shape with rounded corners 706. Faceplates 700 each have a circular groove 708 formed thereon. Sloped edges 710 surround a viewing region 712 where a display of an electronic device may be viewed. FIG. 10A shows a faceplate 714 having a wood grain pattern; FIG. 10B shows another faceplate 716 having a panther print pattern; FIG. 10C shows another faceplate 718 having a zebra print pattern; FIG. 10D shows another faceplate 720 having a camouflage print pattern; and FIG. 10E shows another faceplate 722 having a leopard print pattern.

FIGS. 11A and 11B show two other faceplates with certain design features. Faceplate 800 of FIG. 11A is a Christmas tree-shaped faceplate having a viewing region 802. Faceplate 804 of FIG. 11B is a snowman-shaped faceplate having a viewing region 806.

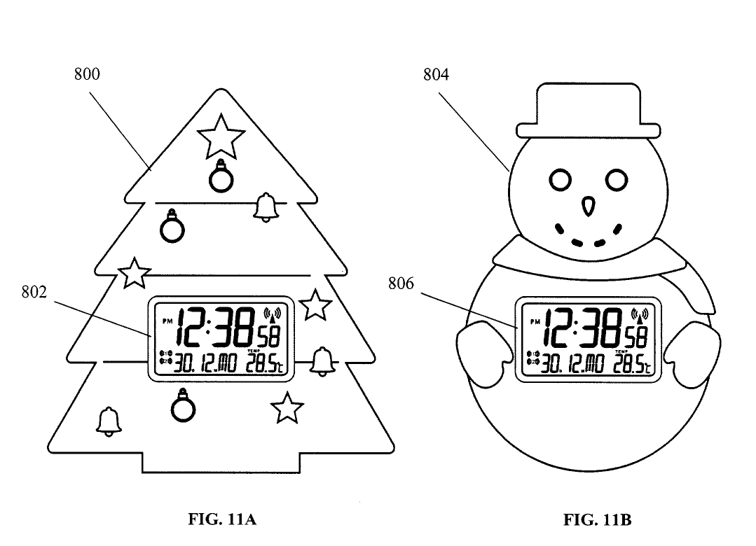

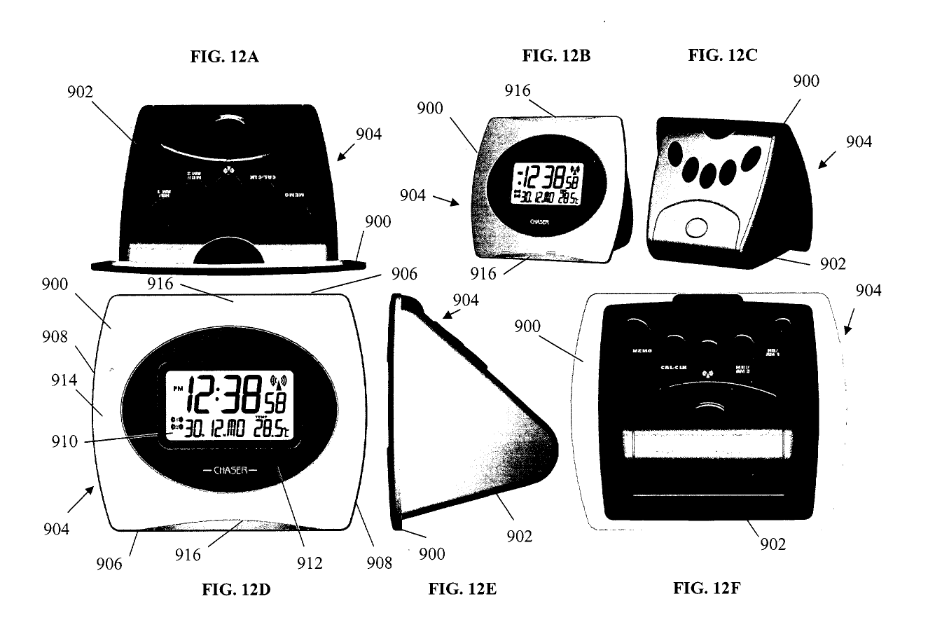

FIGS. 12A-12F show another faceplate 900 with certain design features coupled with a device housing 902 for an electronic device 904, such as device housing 16 of FIGS. 1A-1D. Faceplate 900 has generally parallel upper and lower edges 906, matching outwardly curved side edges 908, and a viewing region 910. An elliptical section 912 may have a first shading characteristic (e.g., darker shade), and an area 914 of faceplate 900 surrounding elliptical section 912 may have a second shading characteristic (e.g., lighter shade). Beveled regions 916 are formed proximal to upper and lower edges 906.

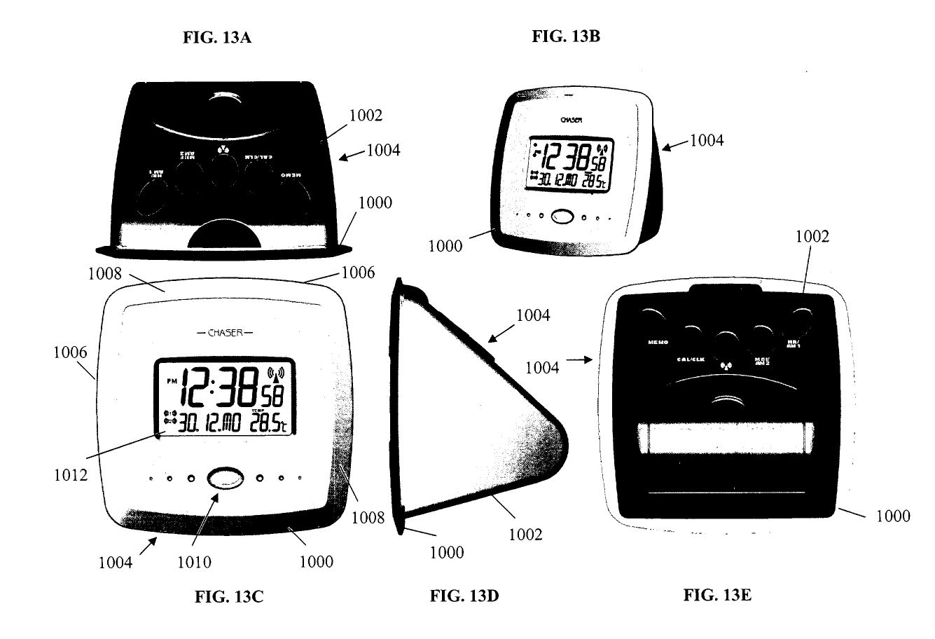

FIGS. 13A-13E show another faceplate 1000 with certain design features coupled with a device housing 1002 for an electronic device 1004, such as device housing 16 of FIGS. 1A-1D. Faceplate 1000 has matching outwardly curved outer edges 1006 and beveled regions 1008 extending to edges 1006. A series of indentions 1010, such as elliptical or circular indentions, may be formed below a viewing region 1012 of the faceplate 1000.

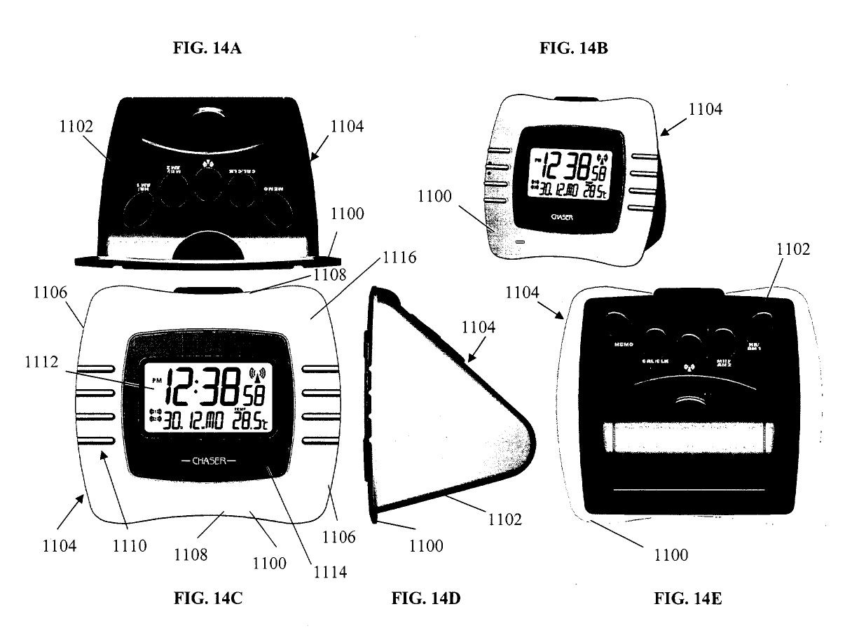

Another faceplate 1100 is shown in FIGS. 14A-14E with certain design features coupled with a device housing 1102 for an electronic device 1104, such as device housing 16 of FIGS. 1A-1D. Faceplate 1100 has matching outwardly curved side edges 1106 and matching inwardly curved top and bottom edges 1108. Horizontally extending elongated indentions 1110 may be formed on faceplate 1100 near side edges 1106 on either side of a viewing region 1112. A four-sided center section 1114 may have a first shading characteristic (e.g., darker shade), and an area 1116 of faceplate 1100 surrounding center section 1114 may have a second shading characteristic (e.g., lighter shade).

FIGS. 15A-15E show another faceplate 1200 with certain design features coupled with a device housing 1202 for an electronic device 1204, such as device housing 16 of FIGS. 1A-1D. Faceplate 1200 has matching outwardly curved side edges 1206, outwardly curved top edge 1208, and inwardly curved bottom edge 1210. An indented center section 1212 may have an elliptical or circular shape to encircle a viewing region 1214.

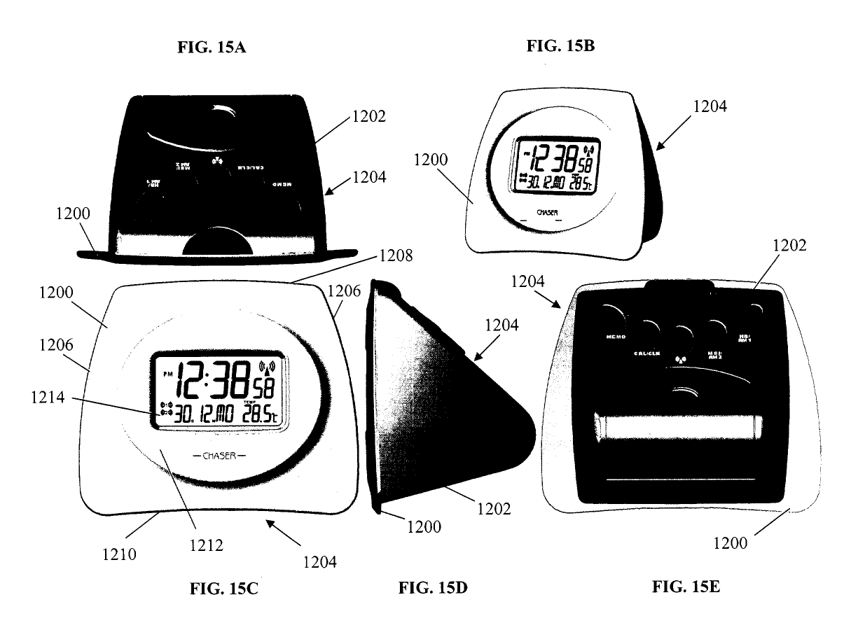

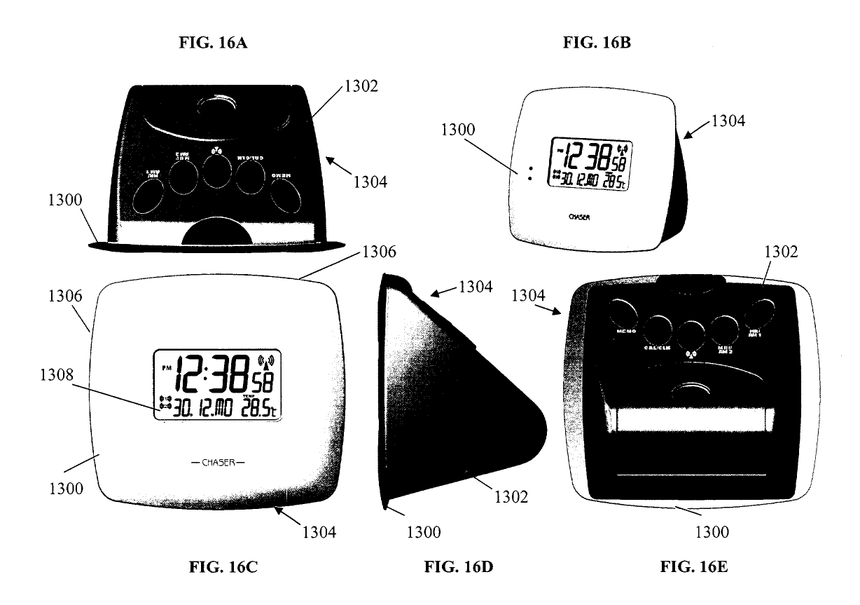

Another faceplate 1300 is shown in FIGS. 16A-16E with certain design features coupled with a device housing 1302 for an electronic device 1304, such as device housing 16 of FIGS. 1A-1D. Faceplate 1300 has matching outwardly curved outer edges 1306 and generally has a convex shape between a viewing region 1308 and edges 1306.

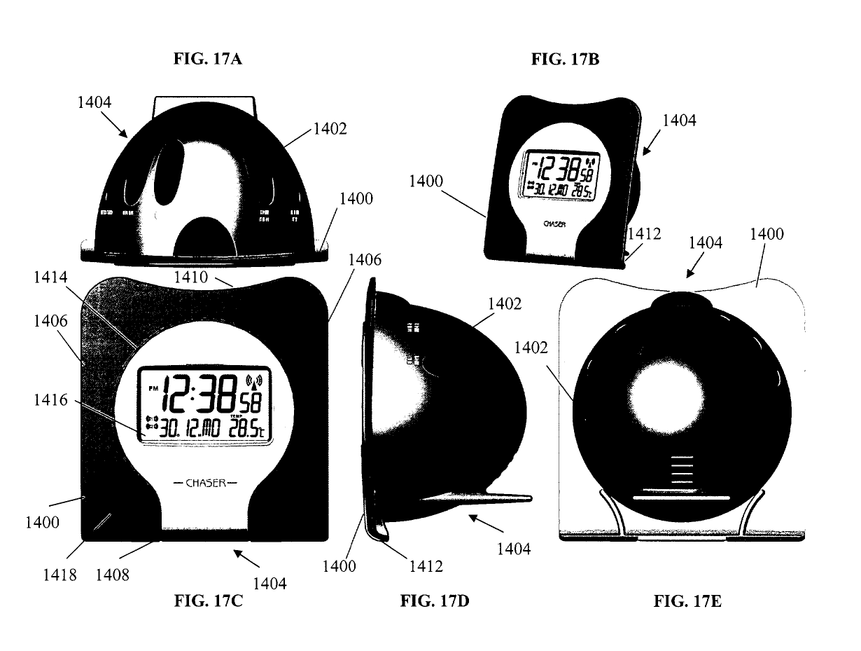

FIGS. 17A-17E show another faceplate 1400 with certain design features coupled with a device housing 1402 for an electronic device 1404, such as device housing 56 of FIGS. 2A-2D. Faceplate 1400 has generally parallel side edges 1406, a straight bottom edge 1408 and an inwardly curved upper edge 1410. A footing 1412 extends rearwardly near bottom edge 1408 to support faceplate 1400. A center section 1414 surrounding a viewing region 1416 and generally having a pinhead shape may have a first shading characteristic (e.g., lighter shade), and an area 1418 of faceplate 1400 surrounding center section 1414 may have a second shading characteristic (e.g., darker shade).

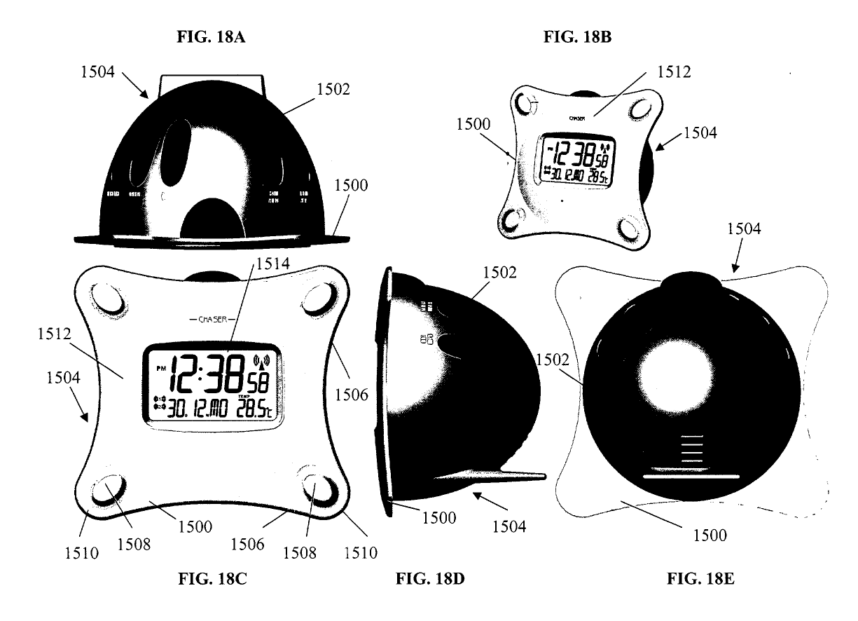

Another faceplate 1500 is shown in FIGS. 18A-18E with certain design features coupled with a device housing 1502 for an electronic device 1504, such as device housing 56 of FIGS. 2A-2D. Faceplate 1500 has four matching inwardly curved outer edges 1506 and four raised areas 1508 position near rounded corners 1510. A center section 1512 may have a raised hemispherical shape to surround a viewing region 1514.

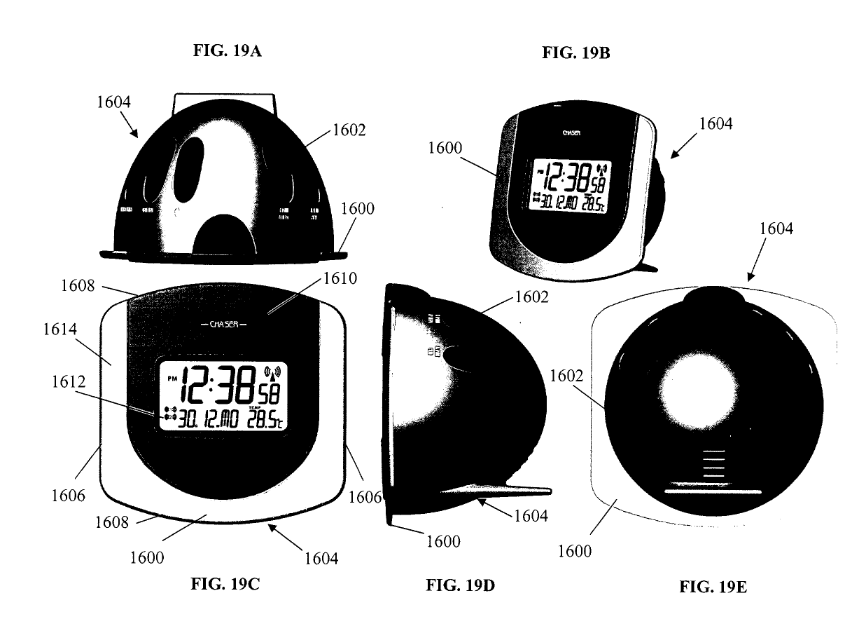

FIGS. 19A-19E show another faceplate 1600 with certain design features coupled with a device housing 1602 for an electronic device 1604, such as device housing 56 of FIGS. 2A-2D. Faceplate 1600 has generally parallel side edges 1606 and matching outwardly curved top and bottom edges 1608. A center section 1610 surrounding a viewing region 1612 generally has a circular lower portion and a vertically straight upper portion, and may have a first shading characteristic (e.g., darker shade), and an area 1614 of faceplate 1600 outside of center section 1610 may have a second shading characteristic (e.g., lighter shade).

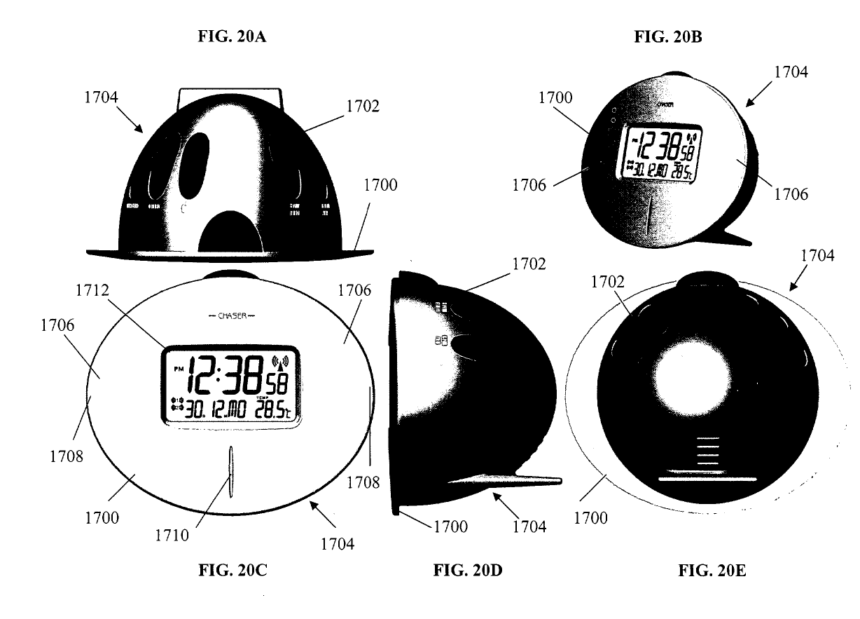

Another faceplate 1700 is shown in FIGS. 20A-20E with certain design features coupled with a device housing 1702 for an electronic device 1704, such as device housing 56 of FIGS. 2A-2D. Faceplate 1700 generally has an elliptical shape and may have beveled regions 1706 formed near lateral sides 1708 of faceplate 1700. A vertically extending elongated indention 1710 may be positioned below a viewing region 1712.

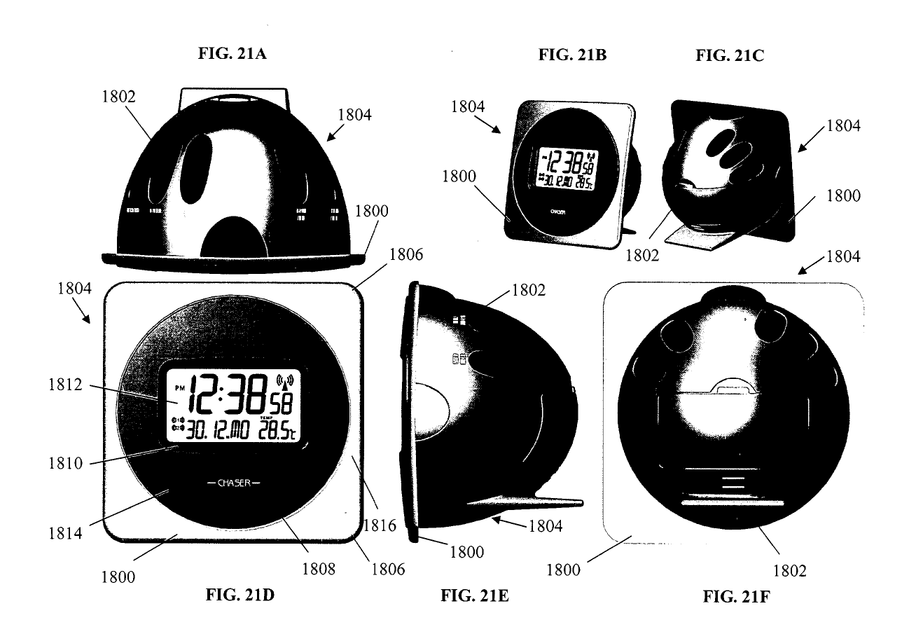

FIGS. 21A-21E show another faceplate 1800 coupled with a device housing 1802 for an electronic device 1804, such as device housing 56 of FIGS. 2A-2D. Faceplate 1800 has generally the same structure as the series of faceplates 700 of FIGS. 10A-10E, but with design features varying from the faceplates 700. Faceplate 1800 has a generally rectangular, or more specifically, square shape with rounded corners 1806. Faceplate 1800 also has a circular groove 1808 formed thereon. A set of sloped edges 1810 surround a viewing region 1812. A generally circular center section 1814 surrounds sloped edges 1810 and viewing region 1812, and may have a first shading characteristic (e.g., darker shade), and an area 1816 of faceplate 1800 outside of center section 1814 may have a second shading characteristic (e.g., lighter shade).

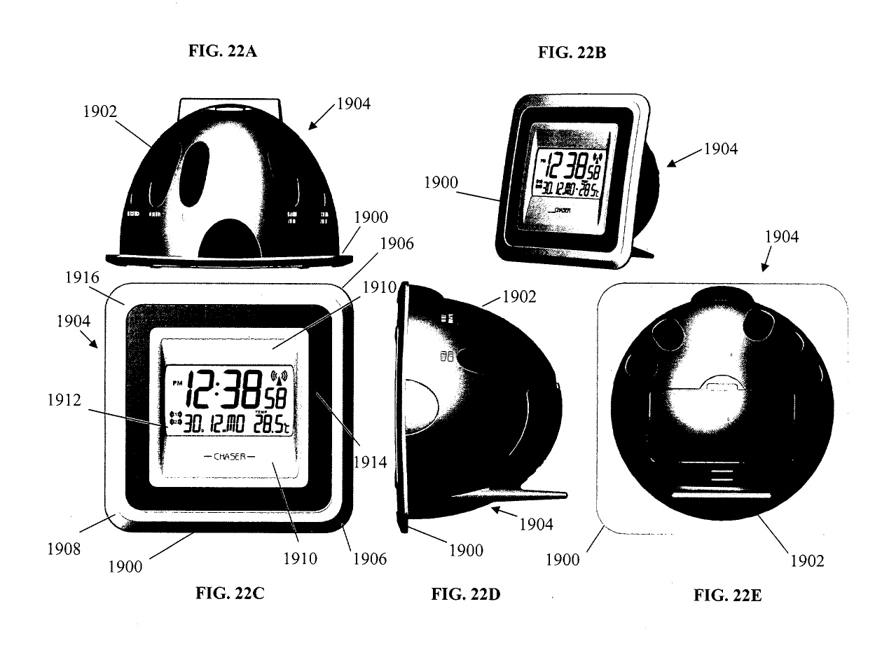

Another faceplate 1900 is shown in FIGS. 22A-22E with certain design features coupled with a device housing 1902 for an electronic device 1904, such as device housing 56 of FIGS. 2A-2D. Faceplate 1900 has a generally rectangular, or more specifically, square shape with rounded corners 1906 and perimeter beveled region 1908. A set of upper and lower sloped edges 1910 define a viewing region 1912 therebetween. A four-sided ring-shaped center section 1914 surrounds viewing region 1912, and may have a first shading characteristic (e.g., darker shade), and an area 1916 of faceplate 1900 outside of center section 1914 may have a second shading characteristic (e.g., lighter shade).

Since certain changes may be made in the above assembly without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. An electronic device and faceplate assembly, comprising:
a faceplate having a viewing region;
an electronic device having a device housing for interfacing with the faceplate;
and
means for coupling the faceplate to the device housing to define a front panel for the electronic device, the means for coupling comprising:
at least one push-button slidably mounted with the device housing proximal to an outer wall thereof, each push-button having a catch; and
at least one pin extending from a back surface of the faceplate, each pin having a hook configured to engage with the catch of each push-button to restrict the outward movement of the hook and secure the faceplate to the device housing.

2. The assembly of claim 1, the at least one push-button comprising two push-buttons disposed on opposite sides of the device housing, each push-button being laterally slidable and further having a spring to bias the push-button catch laterally outward for engaging with the hook of the faceplate, whereby a force applied to each push-button moves the push-button laterally inward from the outer wall of the device housing to release the hook of the faceplate from the catch for decoupling the faceplate from the device housing.

3. The assembly of claim 1, the faceplate having at least one bracing pin extending from the back surface of the faceplate and configured to slidably mate with a corresponding brace of the device housing.

4. The assembly of claim 1, the faceplate viewing region comprising one of a transparent window and a through-hole for viewing a display of the electronic device.

5. An electronic device and faceplate assembly, comprising:
a faceplate having a viewing region;
an electronic device having a device housing for interfacing with the faceplate; and
means for coupling the faceplate to the device housing to define a front panel for the electronic device, the means for coupling comprising:
a threaded ring formed on a back surface of the faceplate; and
a threaded region formed around a perimeter of the device housing and configured to be threadingly received within the threaded ring of the faceplate to secure the faceplate to the device housing.

6. The assembly of claim 5, the faceplate viewing region comprising one of a transparent window and a through-hole for viewing a display of the electronic device.

7. An electronic device and faceplate assembly, comprising:
a faceplate having a viewing region;
an electronic device having a device housing for interfacing with the faceplate;
and
means for coupling the faceplate to the device housing to define a front panel for the electronic device, the means for coupling comprising:
a slot formed proximal to an upper edge of the faceplate on the back surface thereof; and
an angled flange formed on the device housing proximal to an upper region thereof and having an arm offset from a front surface of the device housing to frictionally fit within the slot of the faceplate to secure the faceplate to the device housing.

8. The assembly of claim 7, wherein the slot is upwardly aligned and the angled flange arm extends downward and offset from the front surface of the device housing.

9. The assembly of claim 7, the faceplate viewing region comprising one of a transparent window and a through-hole for viewing a display of the electronic device.

10. An electronic device and faceplate assembly, comprising:
a faceplate having a viewing region;
an electronic device having a device housing for interfacing with the faceplate; and
means for coupling the faceplate to the device housing to define a front panel for the electronic device, the means for coupling comprising:
a plurality of bores formed in a front surface of the device housing;
a plurality of through-holes formed in the faceplate and configured to be alignable with the bores of the device housing; and
a plurality of fasteners each removably insertable through one through-hole of the faceplate and one bore of the device housing to secure the faceplate to the device housing.

11. The assembly of claim 10, the plurality of fasteners each having at least one arm extending from a shaft thereof, each arm having an protrusion extending laterally away from the shaft to frictionally contact the device housing within one of the plurality of bores, the arm being flexible to release the protrusion from contact with the bore of the device housing.

12. The assembly of claim 10, the faceplate viewing region comprising one of a transparent window and a through-hole for viewing a display of the electronic device.

13. An electronic device and faceplate assembly, comprising:
a faceplate having a viewing region;
an electronic device having a device housing for interfacing with the faceplate;
and
means for coupling the faceplate to the device housing to define a front panel for the electronic device, the means for coupling comprising:
a set of angled flanges formed on a back surface of the faceplate; and
a set of angled flanges formed on a front surface of the device housing and aligned in an opposing direction to the angled flanges of the faceplate to slidably fit therewith to secure the faceplate to the device housing.

14. The assembly of claim 13, the faceplate viewing region comprising one of a transparent window and a through-hole for viewing a display of the electronic device.

15. An electronic device and faceplate assembly, comprising:
a faceplate having a viewing region;
an electronic device having a device housing for interfacing with the faceplate; and
means for coupling the faceplate to the device housing to define a front panel for the electronic device, the means for coupling comprising:
a ring formed on a back surface of the faceplate, the ring having a circumferential lip formed on an inside surface thereof; and
an outer lip formed around the circumference of the device housing proximal to a front surface thereof, the outer lip configured to receive the circumferential lip of the ring thereover in an interference fit to secure the faceplate to the device housing.

16. The assembly of claim 15, the faceplate viewing region comprising one of a transparent window and a through-hole for viewing a display of the electronic device.

17. A coupling system for interfacing a faceplate with a household electronic device having a device housing, the faceplate having a viewing region and the electronic device having a display, comprising:
means for releasably coupling the faceplate to the device housing to align the viewing region of the faceplate with the display of the electronic device to define a front panel for the household electronic device.

18. The coupling system of claim 17, the device housing further having a pair of generally triangularly-shaped sidewalls defining therebetween a sloping rearwall and a bottom wall, the rearwall having a plurality of function initiating buttons for the household electronic device.

19. The coupling system of claim 17, the device housing further having a half-hemispherical shape having a plurality of function initiating buttons for the household electronic device, and a rearwardly extending flange for supporting the device housing in an upright position.

20. The coupling system of claim 17, the household electronic device is an alarm clock.

21. The coupling system of claim 17, the household electronic device is a radio clock.

22. The coupling system of claim 17, the household electronic device is a thermometer clock.

23. The coupling system of claim 17, the means for releasably coupling comprising:
at least one push-button slidably mounted within the device housing proximal to an outer wall thereof and outwardly biased, each push-button having a catch; and
at least one pin extending from a back surface of the faceplate and having a hook, each hook configured to engage with the catch of each push-button to secure the faceplate to the device housing.

24. An electronic device and faceplate assembly, comprising:
a faceplate having a front surface, a back surface, and a viewing region, the back surface having at least one pin having a hook, the at least one pin extending from the back surface;
an electronic device having a device housing with a front surface and at least one push-button slidably mounted with the device housing proximal to an outer wall thereof, each push-button being outwardly biased and having a catch for interfacing with the hook of the faceplate;
wherein each hook is configured to be releasably engaged with-the catch of each push-button to secure the faceplate to the front surface of the device housing.
